(19) United States
(12) Patent Application Publication
(10) Pub. No.: US 2025/0096885 A1
(43) Pub. Date: Mar. 20, 2025

(54) UNCREWED AERIAL VEHICLE COMMAND AND CONTROL LINK RELIABILITY OVER CELLULAR NETWORKS

(71) Applicant: AT&T Technical Services Company, Inc., Vienna, VA (US)

(72) Inventor: Daniel Vivanco, Ashburn, VA (US)

(21) Appl. No.: 18/471,254

(22) Filed: Sep. 20, 2023

(51) Int. Cl. H04B 7/185

(52) U.S. Cl. CPC H04B 7/18504

(57) ABSTRACT

A processing system deployed in a cellular network may obtain at least one uplink channel quality measure associated with an uncrewed aerial vehicle, where the uncrewed aerial vehicle includes at least one cellular radio for communication with the cellular network, identify that the at least one uplink channel quality measure is below at least a first threshold quality level, and transmit at least one instruction to implement a transmission time interval bundling between the uncrewed aerial vehicle and a serving cell for command and control traffic of the uncrewed aerial vehicle, in response to identifying that the at least one uplink channel quality measure is below the at least the first threshold quality level.

The present disclosure relates generally to cellular networks, and more particularly to methods, non-transitory computer-readable media, and apparatuses for transmitting at least one instruction to implement a transmission time interval bundling between an uncrewed aerial vehicle and a serving cell for command and control traffic in response to the identifying that at least one uplink channel quality measure is below at least a first threshold quality level.

### BACKGROUND

Current trends in wireless technology are leading towards a future where virtually any object can be network-enabled and addressable on-network. The pervasive presence of cellular and non-cellular wireless networks, including fixed, ad-hoc, and/or or peer-to-peer wireless networks, satellite networks, and the like along with the migration to a 128-bit IPv6-based address space provides the tools and resources for the paradigm of the Internet of Things (IoT) to become a reality. In addition, drones or autonomous aerial vehicles (AAVs) are increasingly being utilized for a variety of commercial and other useful tasks, such as package deliveries, search and rescue, mapping, surveying, and so forth, enabled at least in part by these wireless communication technologies.

### SUMMARY

In one example, the present disclosure discloses a method, computer-readable medium, and apparatus for transmitting at least one instruction to implement a transmission time interval bundling between an uncrewed aerial vehicle and a serving cell for command and control traffic in response to the identifying that at least one uplink channel quality measure is below at least a first threshold quality level. For example, a processing system including at least one processor deployed in a cellular network may obtain at least one uplink channel quality measure associated with an uncrewed aerial vehicle, where the uncrewed aerial vehicle includes at least one cellular radio for communication with the cellular network, identify that the at least one uplink channel quality measure is below at least a first threshold quality level, and transmit at least one instruction to implement a transmission time interval bundling between the uncrewed aerial vehicle and a serving cell for command and control traffic of the uncrewed aerial vehicle, in response to identifying that the at least one uplink channel quality measure is below the at least the first threshold quality level.

### BRIEF DESCRIPTION OF THE DRAWINGS

The teachings of the present disclosure can be readily understood by considering the following detailed description in conjunction with the accompanying drawings, in which:

FIG. 1 illustrates a block diagram of an example system, in accordance with the present disclosure;

FIG. 2 illustrates a flowchart of an example method for transmitting at least one instruction to implement a transmission time interval bundling between an uncrewed aerial vehicle and a serving cell for command and control traffic in response to the identifying that at least one uplink channel quality measure is below at least a first threshold quality level; and

FIG. 3 illustrates a high level block diagram of a computing device specifically programmed to perform the steps, functions, blocks and/or operations described herein.

To facilitate understanding, similar reference numerals have been used, where possible, to designate elements that are common to the figures.

### DETAILED DESCRIPTION

The present disclosure broadly discloses methods, non-transitory computer-readable media, and apparatuses for transmitting at least one instruction to implement a transmission time interval bundling between an uncrewed aerial vehicle and a serving cell for command and control traffic in response to the identifying that at least one uplink channel quality measure is below at least a first threshold quality level. In particular, transmission time interval (TTI) bundling in accordance with the present disclosure improves transmission reliability from a cellular communication-enabled uncrewed aerial vehicle (UAV) to a serving cell, e.g., when the UAV is experiencing severe fading conditions. Furthermore, TTI bundling in accordance with the present disclosure may include instructing a UAV to send the same transport block, but with different error detection and correction bits in a number consecutive transmit time intervals, also known as transmission time interval repetitions.

Notably, use of commercial uncrewed aerial vehicles (UAVs) is growing rapidly, including for delivery of parcels or other items, presentation of media, inspection of critical infrastructure, surveillance, search-and-rescue operations, agriculture inspection and maintenance, and so forth. Many use cases of UAVs require beyond visual line-of-sight (LOS) communications. Mobile networks offer wide area, high speed, and secure wireless connectivity, which can enhance control and safety of UAV operations and enable beyond-visual LOS use cases. Existing LTE networks can support initial UAV deployments, while LTE evolution and 5G may provide more efficient connectivity for more wide-scale UAV deployments.

One challenge in using LTE networks for serving UAVs is the fact that mobile LTE networks are optimized for terrestrial broadband communication. In particular, base station antennas are typically down-tilted to reduce the interference power level to other cells. With down-tilted base station antennas, small UAVs may be served by the generated sidelobes. However, it should be noted that due to the presence of possible nulls in the sidelobes, and due to the close-to-free-space propagation in the sky, an aerial user equipment (UE) (e.g., a UAV) may detect several cell sites (e.g., eNodeBs and/or gNBs, or the like) in the area. In addition, an aerial UE may see a stronger signal from a faraway cell site than the one that is geographically closest. Hence, an aerial UE may be served by a more distant base station/cell site instead of the closest one.

In accordance with the present disclosure, a UAV may use LTE/5G radio technologies to communicate with a ground station, e.g., a UAV control server or other devices. Communications between the UAV and the ground station relating to management and control of the UAV operations may be referred to as a command and control (C2) link. For instance, the C2 link allows an operator to navigate the UAV on a three dimensional trajectory, to understand the state of the UAV, and to control one or more components or accessories (such as to remotely orient a camera, to remotely activate warning lights, sirens, sensors, etc.). In general, the C2 link is used to control the UAV and to receive health and status information of the UAV. In addition to C2 traffic, the UAV may also have a payload data link with the ground station, which is used to pass data that is considered non-critical to UAV operations, such as recorded audio or video, photographs, sensor measurements unrelated to UAV navigation, etc. Since the C2 link carries navigation information that is time sensitive, packet loss and delay on the C2 link can lead to catastrophic issues for the UAV or for third parties.

In accordance with the present disclosure, the C2 link for UAV is provided with a higher priority than payload data. In particular, examples of the present disclosure provide a transmission time interval (TTI) bundling process that improves transmission performance of a UAV C2 link when connected to LTE/5G eNodeB/gNB bases stations. To illustrate, in one example, a cellular network may collect UE capabilities and UE type. If the UE type is “aerial,” the cellular network may then monitor UAV uplink performance. For instance, uplink performance may be quantified via metrics obtained from base station records and/or other network components related to UAV uplink communications (e.g., “key performance indicators” (KPIs)), such as uplink signal-to-noise (SNR) ratio, uplink retransmission delay, and so forth. In one example, the cellular network may map C2 link traffic to a given quality of service (QOS) class identifier (QCI), e.g., a high priority QCI. In one example, if it is determined that the UAV is at a cell edge and uplink performance is deteriorating, which may impact C2-Link performance, then the cellular network may cause the serving base station to activate uplink TTI bundling with the UAV for the C2 link traffic. In particular, the TTI bundling may be activated only with respect to the QCI that is assigned for the C2 link traffic.

It should be noted that TTI bundling creates extra overhead since the data will be transmitted multiple times. It is also noted that while UAV payload data may be considered non-critical, it may use more radio frequency and other network resources than C2 link traffic. Examples of the present disclosure exclude UAV payload data from TTI bundling, which may otherwise create link overload for both payload data traffic and C2 link traffic. In one example, the cellular network may determine the number of TTI repetitions to be used for a UAV at a specific time. If uplink conditions are bad (e.g., below a first threshold for an uplink performance metric) then a first number of TTI repetitions may be used. If uplink conditions worsen (e.g., fall below a second uplink performance threshold), then the number of TTI repetitions may be increased, and so on. In one example, uplink performance improvement may be balanced against the network congestion that TTI bundling may induce.

TTI bundling is a useful technique for improving coverage of time sensitive application such as voice over LTE (VoLTE) or the like. It should be noted that in some implementations TTI bundling may alternatively or additionally be referred to as slot aggregation. In general, TTI bundling aims to improve uplink coverage for UEs at cell edges. For instance, when a base station detects that a UE cannot further increase its transmission power and uplink reception at the base station is deteriorating, the base station may instruct the UE to activate TTI bundling, e.g., to send the same transport block, but with different error detection and correction bits in two or more consecutive transmit time intervals. The advantage of this approach is to reduce signaling overhead on the physical downlink control channel (PDCCH), since a hybrid automatic repeat request (HARQ) process may require a retransmission of the transport block after every TTI that received a negative acknowledgement (NACK). Latency is also reduced as no waiting time is required between the retransmissions. In TTI bundling, if the transport block is not received correctly, the receiver (i.e., the base station in the uplink) may still send a NACK in response to the failure to properly receive the transmission. The bundle process may then be repeated just as it would for an ordinary transport block retransmission.

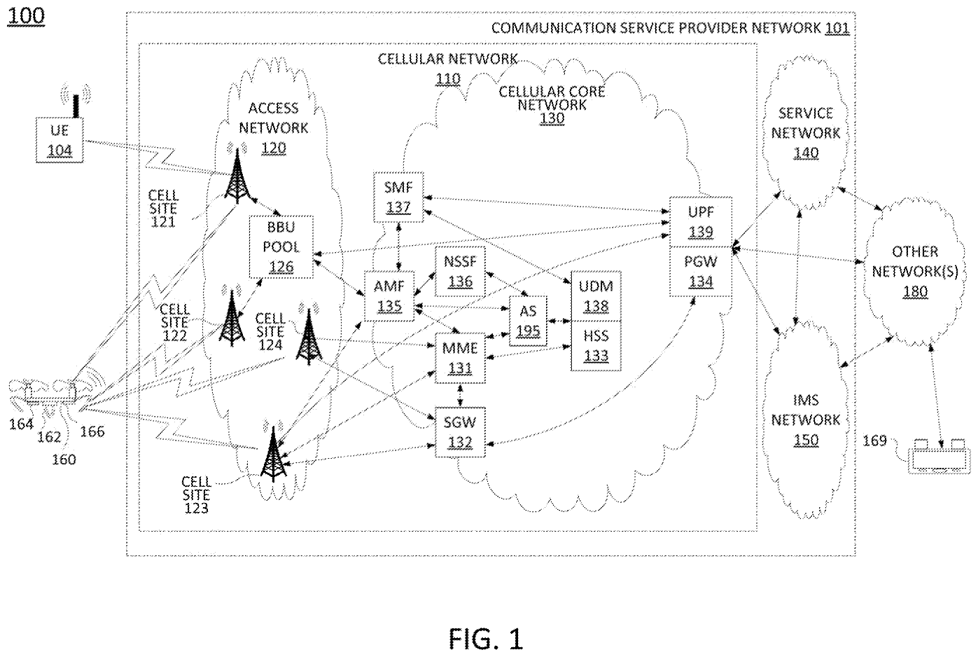

Like other UEs, a UAV attached to a terrestrial cell can be located at the cell edge. Under these circumstances, uplink transmissions may be weakly received, and may involve multiple re-transmission. As such, the C2 link may experience long delays and packet loss, which may lead to unstable and unreliable UAV flight conditions. However, examples of the present disclosure may implement TTI bundling for C2 link traffic on the UAV-to-base station uplink, e.g., to improve uplink transmission under cell edge conditions. Notably, in 3^{rd} Generation Partnership Project Release 8/9/10 specifications, TTI bundling is restricted to bundles of no more than four TTIs, quadrature phase shift keying (QPSK) modulation, and allocations of no more than three physical resource blocks (PRBs) per TTI. In addition, TTI bundling is implemented per UE, and not per QCI/flow. In contrast, examples of the present disclosure may implement uplink TTI bundling for a given QCI, e.g., reserved for C2 link traffic, and not for others. This may prevent uplink congestion due to potential excess utilization for non-critical but high volume payload data (e.g., high-definition (HD) video, or the like). In addition, in one example, the present disclosure may alternatively or additionally enable the use of TTI bundles in excess of four, different modulation coding schemes, and so forth. These and other aspects of the present disclosure are described in greater detail below in connection with the examples of FIGS. 1-3.

FIG. 1 illustrates an example network, or system 100 in which examples of the present disclosure may operate. In one example, the system 100 includes a communication service provider network 101. The communication service provider network 101 may comprise a cellular network 110 (e.g., a 5G network, a 4G/Long Term Evolution (LTE)/5G hybrid network, or the like), a service network 140, and an IP Multimedia Subsystem (IMS) network 150. The system 100 may further include other networks 180 connected to the communication service provider network 101.

In one example, the cellular network 110 comprises an access network 120 and a cellular core network 130. In one example, the access network 120 comprises a cloud RAN. For instance, a cloud RAN is part of the 3GPP 5G specifications for mobile networks. As part of the migration of cellular networks towards 5G, a cloud RAN may be coupled to an Evolved Packet Core (EPC) network until new cellular core networks are deployed in accordance with 5G specifications. In one example, access network 120 may include cell sites 121 and 122 and a baseband unit (BBU) pool 126. In a cloud RAN, radio frequency (RF) components, referred to as remote radio heads (RRHs) or radio units (RUs), may be deployed remotely from baseband units, e.g., atop cell site masts, buildings, and so forth. In one example, the BBU pool 126 may be located at distances as far as 20-80 kilometers or more away from the antennas/remote radio heads of cell sites 121 and 122 that are serviced by the BBU pool 126. It should also be noted in accordance with efforts to migrate to 5G networks, cell sites may be deployed with new antenna and radio infrastructures such as multiple input multiple output (MIMO) antennas, and millimeter wave antennas. In this regard, a cell, e.g., the footprint or coverage area of a cell site may in some instances be smaller than the coverage provided by NodeBs or eNodeBs of 3G-4G RAN infrastructure. For example, the coverage of a cell site utilizing one or more millimeter wave antennas may be 1000 feet or less.

Although cloud RAN infrastructure may include distributed RRHs and centralized baseband units, a heterogeneous network may include cell sites where RRH and BBU components remain co-located at the cell site. For instance, cell site 123 may include RRH and BBU components. Thus, cell site 123 may comprise a self-contained “base station.” With regard to cell sites 121 and 122, the “base stations” may comprise RRHs at cell sites 121 and 122 coupled with respective baseband units of BBU pool 126. In one example, baseband unit functionality may be split into a centralized unit (CU) and a distributed unit (DU). In addition, the CU and the DU may be physically separate from one another. For instance, a DU may be situated with an RU/RRH at a cell site, while a CU may be in a centralized location hosting multiple CUs. Alternatively, or in addition, a single CU may serve multiple DUs and/or RUs/RRHs. In accordance with the present disclosure a “base station” may therefore comprise at least a BBU (e.g., in one example, a CU and/or a DU), and may further include at least one RRH/RU.

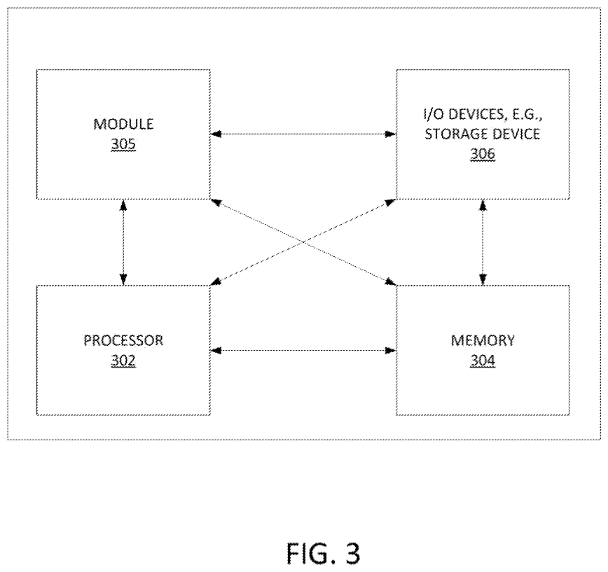

In accordance with the present disclosure, any one or more of cell sites 121-123 may be deployed with antenna and radio infrastructures, including multiple input multiple output (MIMO) and millimeter wave antennas. Furthermore, in accordance with the present disclosure, a base station (e.g., cell sites 121-123 and/or baseband units within BBU pool 126) may comprise all or a portion of a computing system, such as computing system 300 as depicted in FIG. 3, and may be configured to perform steps, functions, and/or operations in connection with examples of the present disclosure for transmitting at least one instruction to implement a transmission time interval bundling between an uncrewed aerial vehicle and a serving cell for command and control traffic in response to the identifying that at least one uplink channel quality measure is below at least a first threshold quality level.

In one example, access network 120 may include both 4G/LTE and 5G/NR radio access network infrastructure. For example, access network 120 may include cell site 124, which may comprise 4G/LTE base station equipment, e.g., an eNodeB. In addition, access network 120 may include cell sites comprising both 4G and 5G base station equipment, e.g., respective antennas, feed networks, baseband equipment, and so forth. For instance, cell site 123 may include both 4G and 5G base station equipment and corresponding connections to 4G and 5G components in cellular core network 130. Although access network 120 is illustrated as including both 4G and 5G components, in another example, 4G and 5G components may be considered to be contained within different access networks. Nevertheless, such different access networks may have a same wireless coverage area, or fully or partially overlapping coverage areas.

In one example, the cellular core network 130 provides various functions that support wireless services in the LTE environment. In one example, cellular core network 130 is an Internet Protocol (IP) packet core network that supports both real-time and non-real-time service delivery across a LTE network, e.g., as specified by the 3GPP standards. In one example, cell sites 121 and 122 in the access network 120 are in communication with the cellular core network 130 via baseband units in BBU pool 126.

In cellular core network 130, network devices such as Mobility Management Entity (MME) 131 and Serving Gateway (SGW) 132 support various functions as part of the cellular network 110. For example, MME 131 is the control node for LTE access network components, e.g., eNodeB aspects of cell sites 121-123. In one embodiment, MME 131 is responsible for UE (User Equipment) tracking and paging (e.g., such as retransmissions), bearer activation and deactivation process, selection of the SGW, and authentication of a user. In one embodiment, SGW 132 routes and forwards user data packets, while also acting as the mobility anchor for the user plane during inter-cell handovers and as an anchor for mobility between 5G, LTE and other wireless technologies, such as 2G and 3G wireless networks.

In addition, cellular core network 130 may comprise a Home Subscriber Server (HSS) 133 that contains subscription-related information (e.g., subscriber profiles), performs authentication and authorization of a wireless service user, and provides information about the subscriber's location. The cellular core network 130 may also comprise a packet data network (PDN) gateway (PGW) 134 which serves as a gateway that provides access between the cellular core network 130 and various packet data networks (PDNs), e.g., service network 140, IMS network 150, other network(s) 180, and the like.

The foregoing describes long term evolution (LTE) cellular core network components (e.g., EPC components). In accordance with the present disclosure, cellular core network 130 may further include other types of wireless network components e.g., 5G network components, 3G network components, etc. Thus, cellular core network 130 may comprise an integrated network, e.g., including any two or more of 2G-5G infrastructures and technologies (or any future infrastructures and technologies to be deployed, e.g., 6G), and the like. For example, as illustrated in FIG. 1, cellular core network 130 further comprises 5G components, including: an access and mobility management function (AMF) 135, a network slice selection function (NSSF) 136, a session management function (SMF) 137, a unified data management function (UDM) 138, and a user plane function (UPF) 139.

In one example, AMF 135 may perform registration management, connection management, endpoint device reachability management, mobility management, access authentication and authorization, security anchoring, security context management, coordination with non-5G components, e.g., MME 131, and so forth. NSSF 136 may select a network slice or network slices to serve an endpoint device, or may indicate one or more network slices that are permitted to be selected to serve an endpoint device. For instance, in one example, AMF 135 may query NSSF 136 for one or more network slices in response to a request from an endpoint device to establish a session to communicate with a PDN. The NSSF 136 may provide the selection to AMF 135, or may provide one or more permitted network slices to AMF 135, where AMF 135 may select the network slice from among the choices. A network slice may comprise a set of cellular network components, such as AMF(s), SMF(s), UPF(s), and so forth that may be arranged into different network slices which may logically be considered to be separate cellular networks. In one example, different network slices may be preferentially utilized for different types of services. For instance, a first network slice may be utilized for sensor data communications, Internet of Things (IoT), and machine-type communication (MTC), a second network slice may be used for streaming video services, a third network slice may be utilized for voice calling, a fourth network slice may be used for gaming services, and so forth. In accordance with the present disclosure, a network slice may be dedicated to UAV type UEs as described herein.

In one example, SMF 137 may perform endpoint device IP address management, UPF selection, UPF configuration for endpoint device traffic routing to an external packet data network (PDN), charging data collection, quality of service (QOS) enforcement, and so forth. UDM 138 may perform user identification, credential processing, access authorization, registration management, mobility management, subscription management, and so forth. As illustrated in FIG. 1, UDM 138 may be tightly coupled to HSS 133. For instance, UDM 138 and HSS 133 may be co-located on a single host device, or may share a same processing system comprising one or more host devices. In one example, UDM 138 and HSS 133 may comprise interfaces for accessing the same or substantially similar information stored in a database on a same shared device or one or more different devices, such as subscription information, endpoint device capability information, endpoint device location information, and so forth. For instance, in one example, UDM 138 and HSS 133 may both access subscription information or the like that is stored in a unified data repository (UDR) (not shown).

UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. In this regard, it should be noted that UPF 139 and PGW 134 may provide the same or substantially similar functions, and in one example, may comprise the same device, or may share a same processing system comprising one or more host devices.

It should be noted that other examples may comprise a cellular network with a “non-stand alone” (NSA) mode architecture where 5G radio access network components, such as a “new radio” (NR), “gNodeB” (or “gNB”), and so forth are supported by a 4G/LTE core network (e.g., an EPC network), or a 5G “standalone” (SA) mode point-to-point or service-based architecture where components and functions of an EPC network are replaced by a 5G core network (e.g., an “NC”). For instance, in non-standalone (NSA) mode architecture, LTE radio equipment may continue to be used for cell signaling and management communications, while user data may rely upon a 5G new radio (NR), including millimeter wave communications, for example. However, examples of the present disclosure may also relate to a hybrid, or integrated 4G/LTE-5G cellular core network such as cellular core network 130 illustrated in FIG. 1. In this regard, FIG. 1 illustrates a connection between AMF 135 and MME 131, e.g., an “N26” interface which may convey signaling between AMF 135 and MME 131 relating to endpoint device tracking as endpoint devices are served via 4G or 5G components, respectively, signaling relating to handovers between 4G and 5G components, and so forth.

In one example, service network 140 may comprise one or more devices for providing services to subscribers, customers, and or users. For example, communication service provider network 101 may provide a cloud storage service, web server hosting, and other services. For instance, in one example, service network 140 may provide a cloud storage service for UAV payload data as described herein. As such, service network 140 may represent aspects of communication service provider network 101 where infrastructure for supporting such services may be deployed. In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 180 may include different types of networks. In another example, the other networks 180 may be the same type of network. In one example, the other networks 180 may represent the Internet in general. In this regard, it should be noted that any one or more of service network 140, other networks 180, or IMS network 150 may comprise a packet data network (PDN) to which an endpoint device may establish a connection via cellular core network 130 in accordance with the present disclosure.

FIG. 1 further illustrates a ground station 169, e.g., a UAV control system, which may communicate with one or more UAVs, e.g., via communication service provider network 101 and other network(s) 180. For instance, ground station 169 may provide command and control C2 instructions to one or more UAVs, such as UAV 160. In addition, ground station 169 may receive C2 communications from one or more UAVs, such as current position information, speed/velocity, battery status and/or other status indicators, apparent wind speed measurements, LiDAR or similar data, and so forth. In one example, ground station 169 may further receive and/or transmit payload data, such as video or images recorded by one or more UAV cameras, video or images to present via one or more UAV-based screens/displays, etc. In one example, the ground station 169 may comprise a computing device or processing system, such as computing system 300 depicted in FIG. 3, and may be configured to perform operations in connection with various examples as described herein.

In one example, one or more UAVs may be remote controlled by one or more human operators via ground station 169. For instance, ground station 169 may include a display for presenting a video feed from a UAV, may include a joystick or other user interface components for providing control/navigation signals for operating the UAV and so forth. Alternatively, or in addition, ground station 169 may comprise an automated UAV management server/platform. For instance, ground station 169 may provide dispatch and monitoring services with respect to a fleet of one or more UAVs. Thus, for example, ground station 169 may communicate with UAV 160 and/or other UAVs to provide dispatch/pickup locations, destination/drop-off locations, routes, and the like. Similarly, ground station 169 may communicate with UAV 160 and/or other UAVs to monitor battery or fuel reserve, to command UAVs to recharge and/or to refuel, to direct such UAVs to refueling or recharging locations, locations to swap batteries, and so on.

In one example, any one or more of the components of cellular core network 130 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 131 may comprise a vMME, SGW 132 may comprise a vSGW, and so forth. Similarly, AMF 135, NSSF 136, SMF 137, UDM 138, and/or UPF 139 may also comprise NFVI configured to operate as VNFs. In addition, when comprised of various NFVI, the cellular core network 130 may be expanded (or contracted) to include more or less components than the state of cellular core network 130 that is illustrated in FIG. 1. It should be noted that intermediate devices and links between MME 131, SGW 132, cell sites 121-124, PGW 134, AMF 135, NSSF 136, SMF 137, UDM 138, and/or UPF 139, and other components of system 100 are also omitted for clarity, such as additional routers, switches, gateways, and the like.

FIG. 1 also illustrates various endpoint devices, e.g., user equipment (UE) 104 and UAV 160. UE 104 may comprise a cellular telephone, a smartphone, a tablet computing device, a laptop computer, a pair of computing glasses, a wireless enabled wristwatch, a wireless transceiver for a fixed wireless broadband (FWB) deployment, or any other cellular-capable mobile telephony and computing device (broadly, “an endpoint device”). In accordance with the present disclosure, UAV 160 may include at least a camera 162 and one or more radio frequency (RF) transceivers 166 for cellular communications and/or for non-cellular wireless communications. In one example, UAV 160 may also include a module 164 with one or more additional controllable components, such as a microphone, an infrared, ultraviolet or visible spectrum light source, a display, a loudspeaker, and so forth. In one example, UAV 160 may be equipped with one or more directional antennas, or antenna arrays (e.g., having a half-power azimuthal beamwidth of 120 degrees or less, 90 degrees or less, 60 degrees or less, etc.), e.g., MIMO antenna(s) to receive and/or to transmit multi-path and/or spatial diversity signals. UAV 160 may also include a gyroscope and compass to determine orientation(s), a global positioning system (GPS) receiver for determining a location (e.g., in latitude and longitude, or the like), and so forth. In one example, UAV 160 may also be configured to determine location/position from near field communication (NFC) technologies, such as Wi-Fi direct and/or other IEEE 802.11 communications or sensing (e.g., in relation to beacons or reference points in an environment), IEEE 802.15 based communications or sensing (e.g., “Bluetooth”, “ZigBee”, etc.), and so forth. It should be noted that UE 104 may be similarly equipped, e.g., with MIMO antenna(s), GPS receiver, etc.

In one example, UAV 160 may comprise all or a portion of a computing system, such as computing system 300 depicted in FIG. 3, and may be configured to perform steps, functions, and/or operations in connection with examples of the present disclosure for transmitting at least one instruction to implement a transmission time interval bundling between an uncrewed aerial vehicle and a serving cell for command and control traffic in response to the identifying that at least one uplink channel quality measure is below at least a first threshold quality level. In this regard, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

As illustrated in FIG. 1, UE 104 may access wireless services via the cell site 121 (e.g., NR alone, where cell site 121 comprises a gNB), while UAV 160 may access wireless services via any of the cell sites 121-124 located in the access network 120 (e.g., for NR non-dual connectivity, for LTE non-dual connectivity, for NR-NR DC, for LTE-LTE DC, for EN-DC, and/or for NE-DC). For instance, in one example, UAV 160 may establish and maintain connections to the cellular core network 130 via one or multiple gNBs (e.g., cell sites 121 and 122 and/or cell sites 121 and 122 in conjunction with BBU pool 126 and/or various other components, such as a CU and/or a DU). In another example, UAV 160 may establish and maintain connections to the cellular core network 130 via a gNB (e.g., cell site 122 and/or cell site 122 in conjunction with BBU pool 126) and an eNodeB (e.g., cell site 124), respectively. In addition, either the gNB or the eNodeB may comprise a PCell, and the other may comprise a SCell for carrier aggregation and/or dual connectivity. Similarly, UAV 160 may communicate with any of the cell sites 121 and 122 using carrier aggregation (CA) (e.g., in accordance with a CA technique). Furthermore, either or both of NR/5G and or EPC (4G/LTE) core network components may manage the communications between UAV 160 and the cellular network 110 via cell site 122 and cell site 124.

In one example, UAV 160 may also utilize different antenna arrays for 4G/LTE and 5G/NR, respectively. For instance, 5G antenna arrays may be arranged for beamforming in a frequency band designated for 5G high data rate communications. For instance, the antenna array for 5G may be designed for operation in a frequency band greater than 5 GHZ. In one example, the array for 5G may be designed for operation in a frequency band greater than 20 GHz. In contrast, an antenna array for 4G may be designed for operation in a frequency band less than 5 GHZ, e.g., 500 MHz to 3 GHz. In addition, in one example, the 4G antenna array (and/or the RF or baseband processing components associated therewith) may not be configured for and/or be capable of beamforming. Accordingly, in one example, UAV 160 may turn off a 4G/LTE radio, and may activate a 5G radio to send a request to activate a 5G session to cell site 122 (e.g., when it is chosen to operate in a non-DC mode or an intra-RAT dual connectivity mode), or may maintain both radios in an active state for multi-radio (MR) dual connectivity (MR-DC).

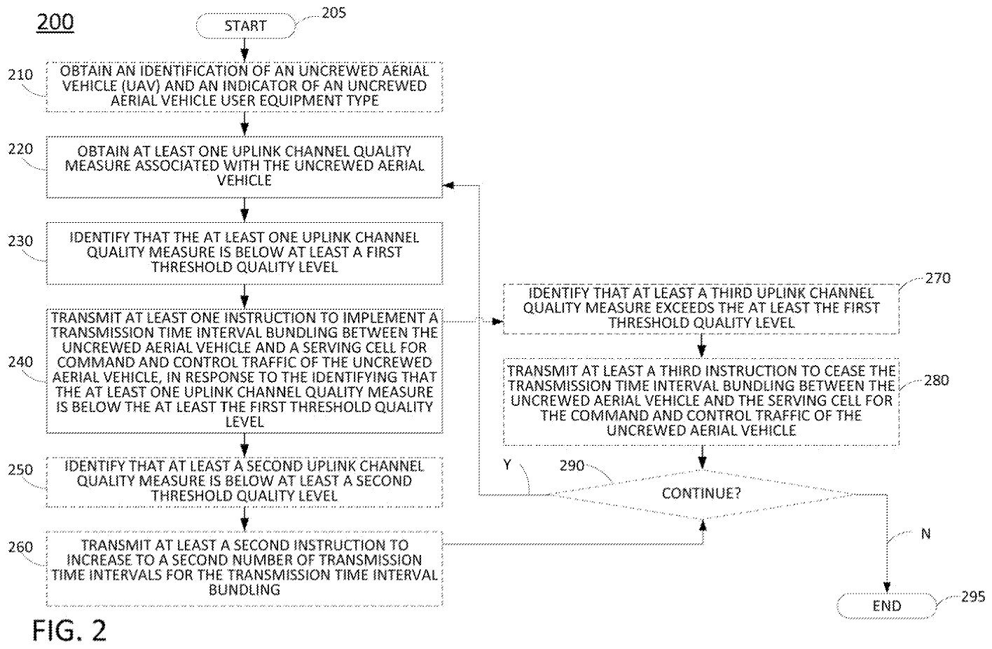

In accordance with the present disclosure, UAV 160 may attach to any cell (e.g., a cell site/base station) of access network 120 and may provide an identification and an indication of a UE type (e.g., aerial UE/UAV) to the cellular network 110. The cellular network 110 may then obtain uplink channel quality measures associated with UAV 160, e.g., on an ongoing basis, and identify that at least one uplink channel quality measure is below at least a first threshold quality level. For instance, a serving cell may track an uplink signal to noise ratio (e.g., in reference to an uplink sounding reference signal (SRS), demodulation reference signal (DM-RS), physical uplink control channel (PUCCH) transmission, or the like), an uplink retransmission measure, an uplink delay measure, or the like. In response thereto, the cellular network 110 may transmit at least one instruction to implement TTI bundling between UAV 160 and the serving cell for C2 traffic of the UAV 160, e.g., for the uplink. The instruction may identify TTI bundling is to be implemented for a particular QCI to which the C2 traffic is assigned. In one example, a HARQ technique may be applied to payload data of the UAV 160 (e.g., non-C2 traffic). Additional operations in connection with examples of the present disclosure for transmitting at least one instruction to implement a transmission time interval bundling between an uncrewed aerial vehicle and a serving cell for command and control traffic in response to the identifying that at least one uplink channel quality measure is below at least a first threshold quality level are described in greater detail below in connection with the example(s) of FIG. 2.

In addition, in various examples, UAV 160 may measure and report to cell sites a signal to noise ratio (SNR, or SINR). For instance, UAV 160 may receive a channel state information (CSI) reference signal from cell site 121, cell site 122, or the like. In addition, UAV 160 may measure the SNR and may report the measurement to the cellular network 110 (e.g., reporting to the cell site that transmitted the reference signal, or to a different cell site). In one example UAV 160 may alternatively or additionally measure and report throughput, e.g., on a dedicated or primary data radio bearer, on a secondary data radio bearer, etc. In one example, the UAV 160 may transmit SINR and/or throughput measurements as messages via a DCCH logical channel over a signaling resource bearer (SRB), such as SRB 1 and/or SRB 3. For instance, the message(s) may be transmitted to one of the cell sites 121-124 to which the UAV 160 maintains an RRC connected state. In one example, the cellular network 110 may alternatively or additionally utilize downlink channel quality measures to infer uplink channel quality and to determine whether and when to implement uplink TTI bundling for the CQI designated for UAV C2 link traffic (e.g., with designated mappings and/or thresholds for commencing TTI bundling, for increasing the bundle size, etc.) (or whether and when to implement a downlink TTI bundling for C2 traffic of UAV 160). UAV 160 may further receive and implement instructions from the cellular network 110 regarding whether to utilize TTI bundling, and a bundle size for when TTI bundling for C2 link traffic is being used, e.g., in addition to instructions for a transmission power level/class etc., whether to utilize an OFDM waveform or DFT waveform, a modulation coding scheme to utilize, and so forth.

It should be noted that examples of the present disclosure as described herein primarily in connection with steps, functions, and/or operations that are performed by a cellular base station. For instance, FIG. 2 illustrates a flowchart of an example method that may be performed by a serving cell (e.g., a base station and/or any one or more components thereof). However, in other, further, and different examples, various steps, functions, and/or operations as described in connection with FIG. 2, or as described elsewhere herein, may alternatively or additionally be performed by one or more other components. For instance, various steps, functions, and/or operations may alternatively or additionally be performed by a processing system in cellular core network 130, such as application server (AS) 195, AMF 135, SMF 137, MME 131, or the like. To illustrate, in an example in which the foregoing is performed by a base station/cell site, the transmitting of the at least one instruction may be via the base station/cell site to UAV 160. However, in an example in which the foregoing may be performed by AS 195, AMF 135, SMF 137, MME 131, or the like, the instruction may be to a cell sites/base station serving UAV 160 to implement uplink TTI bundling for a given QCI and/or to change the parameters thereof (e.g., to change the TTI bundle size, etc.).

The foregoing description of the system 100 is provided as an illustrative example only. In other words, the example of system 100 is merely illustrative of one network configuration that is suitable for implementing examples of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In another example, the NSSF 136 may be integrated within the AMF 135. In addition, cellular core network 130 may also include additional 5G NG core components, such as: a policy control function (PCF), an authentication server function (AUSF), a network repository function (NRF), and other application functions (AFs). In one example, any one or more of cell sites 121-123 may comprise 2G, 3G, 4G and/or LTE radios, e.g., in addition to 5G new radio (NR), or gNB functionality. For instance, cell site 123 is illustrated as being in communication with AMF 135 in addition to MME 131 and SGW 132. Thus, these and other modifications are all contemplated within the scope of the present disclosure.

FIG. 2 illustrates a flowchart of an example method 200 for transmitting at least one instruction to implement a transmission time interval bundling between an uncrewed aerial vehicle and a serving cell for command and control traffic in response to the identifying that at least one uplink channel quality measure is below at least a first threshold quality level, in accordance with the present disclosure. In one example, steps, functions and/or operations of the method 200 may be performed by a device as illustrated in FIG. 1, e.g., any of cell sites 121-124 and/or BBU pool 126 (e.g., including a CU and/or a DU, or the like), AS 195, SMF 137, MME 131, NSSF 136, AMF 135, and so forth, or any one or more components thereof, such as a processing system, or collectively via a plurality devices in FIG. 1, such as any one or more of cell sites 121-124, AS 195, SMF 137, MME 131, NSSF 136, or AMF 135, in conjunction with another of such components, or one or more other entities, such a network repository function, and so forth. In one example, the steps, functions, or operations of method 200 may be performed by a computing device or system 300, and/or a processing system 302 as described in connection with FIG. 3 below. Similarly, in one example, the steps, functions, or operations of method 200 may be performed by a processing system comprising one or more computing devices collectively configured to perform various steps, functions, and/or operations of the method 200. For instance, multiple instances of the computing device or processing system 300 may collectively function as a processing system. For illustrative purposes, the method 200 is described in greater detail below in connection with an example performed by a processing system, such as processing system 302. The method 200 begins in step 205 and may proceed to optional step 210 or to step 220.

At optional step 210, the processing system may obtain an identification of an uncrewed aerial vehicle (UAV) and an indicator of a UAV user equipment type (e.g., an indicator that distinguishes from other UE types that are not UAVs). In one example, the identification of the UAV and the indicator of the UAV UE type may be obtained as part of a network attach procedure. In this regard, it should be noted that the UAV may include at least one cellular radio for communication with the cellular network.

At step 220, the processing system obtains at least one uplink channel quality measure associated with the UAV. For instance, the at least one uplink channel quality measure may comprise one or more of: an uplink signal to noise ratio (e.g., in reference to an uplink sounding reference signal (SRS), demodulation reference signal (DM-RS), physical uplink control channel (PUCCH) transmission, or the like), an uplink retransmission measure, an uplink delay measure, or the like. For example, the processing system may track on an ongoing basis the uplink SNR, uplink retransmission measure, uplink delay measure, etc.

At step 230, the processing system identifies that the at least one uplink channel quality measure is below at least a first threshold quality level. In one example, the at least the first threshold quality level may comprise a first threshold quality level relating to a first type of channel quality measure, or may comprise a plurality of threshold quality levels, each relating to a different type of channel quality measure. Alternatively, or in addition, the at least the first threshold quality level may be for a composite metric associated with two or more uplink channel quality measures of the at least one uplink channel quality measure. For instance, the composite metric may be a weighted combination of an uplink SNR and uplink retransmission measure, or the like.

At step 240, the processing system may transmit at least one instruction to implement a TTI bundling between the UAV and a serving cell for command and control (C2) traffic of the UAV. In particular, step 240 may be implemented in response to the identifying at step 230 that the at least one uplink channel quality measure is below the at least the first threshold quality level. In accordance with the present disclosure, a data payload traffic of the UAV may remain limited to a single transmission time interval. In other words, the first data payload traffic may be excluded from the TTI bundling. As noted above, the first payload data may comprise image data captured by the UAV. With respect to uplink payload, the image data may comprise video but can also include digital photographs, LiDAR images, etc. In addition, the first data payload traffic may alternatively or additionally include sensor data, such as magnetic flux readings from a sensor array, sound data from a microphone or acoustic array, etc.

As noted above, the command and control traffic of the UAV may be assigned to a first quality of service class (e.g., having a particular QCI), while a data payload traffic of the UAV (e.g., including at least the first data payload traffic) may be assigned to a second quality of service class (e.g., having a different QCI). Accordingly, in one example, the at least one instruction may identify that the TTI bundling is to be applied only to the first quality of service class for the UAV. It should be noted that the term “first” does not necessarily indicate that it is the highest QoS class and “second” does not necessarily indicate that it is the second highest QoS class, only that first class has priority relative to the second class. In one example, the different QoS classes may have different assigned carriers. In one example, a HARQ technique may be applied to the data payload traffic of the UAV (e.g., to the second QoS class). In an example in which the processing system is a processing system of a base station/cell site (e.g., of the serving cell), the transmitting of the at least one instruction may be via the base station/cell site to the UAV. However, in an example in which the foregoing may be performed by a cellular core network component, the instruction may be to a cell site/base station serving the UAV (e.g., where the base station/cell site may further instruct the UAV).

In one example, the transmitting of the at least one instruction is further based upon the indicator of the UAV user equipment type. In other words, the process of the method 200 may be specifically for aerial/UAV type UEs. In one example, the at least one instruction is to implement TTI bundling between the UAV and the serving cell for an uplink portion of the command and control traffic of the UAV. In one example, the at least one instruction is to implement the TTI bundling with a first number of a transmission time intervals. For instance, a specific number may be specified in the at least one instruction, or in the absence of any particular number specified, a number may be assumed according to a predefined scheme (e.g., initially two TTIs, which may later be increased if channel conditions worsen). Following step 240, the method 200 may proceed to either of optional steps 250 or 270, to optional step 290, or to step 295.

At optional step 250, the processing system may identify that at least a second uplink channel quality measure is below at least a second threshold quality level. For instance, optional step 250 may be similar to step 230, but with respect to a second threshold quality level that is lower than the first threshold quality level. In other words, optional step 250 may comprise detecting worsening channel conditions between the UAV and the serving cell.

At optional step 260, the processing system may transmit at least a second instruction to increase to a second number of transmission time intervals (e.g., a bundle size) for the TTI bundling. It should be noted that the second number is larger than the first number of TTIs that may be implemented in accordance with step 240.

At optional step 270, the processing system may identify that at least a third uplink channel quality measure exceeds the at least the first threshold quality level. It should also be noted that although the terms, “first,” “second,” “third,” etc., are used herein, the use of these terms are intended as labels only. Thus, the use of a term such as “third” in one example does not necessarily imply that the example must in every case include a “first” and/or a “second” of a similar item. In other words, the use of the terms “first,” “second,” “third,” and “fourth,” does not necessarily imply a particular number of those items corresponding to those numerical values. In addition, the use of the term “third” for example, does not imply a specific sequence or temporal relationship with respect to a “first” and/or a “second” of a particular type of item, unless otherwise indicated.

At optional step 280, the processing system may transmit at least a third instruction to cease the TTI bundling between the UAV and the serving cell for the command and control traffic of the UAV. For instance, the UAV may navigate into a zone in which the channel conditions have improved, such as moving away from a cell edge and closer to the cell site/base station.

At optional step 290, the processing system may determine whether to continue. If yes, the method 200 may return to step 220. Otherwise, the method 200 may proceed to step 295 where the method 200 ends. For instance, the method 200 may continue on an ongoing basis for a duration of time in which the UAV is attached to the serving cell, until the UAV lands and/or is deactivated, and so forth. As such, the processing system may continue to activate and/or deactivate TTI bundling for the UAV command and control traffic, to change the bundle size, and so forth.

Following step 240 or one of optional steps 250-290, the method 200 may proceed to step 295 where the method 200 ends.

It should be noted that the method 200 may be expanded to include additional steps or may be modified to include additional operations or omit operations with respect to the steps outlined above. For instance, in one example, the method 200 may further include the detection of the at least one uplink channel quality measure exceeding one or more additional thresholds, and further increasing a TTI bundle size (e.g., according to a predefined channel quality measure-to-TTI bundle size mapping). It should be noted that in accordance with the present disclosure, TTI bundle sizes may be increased to accommodate larger bundle sizes, e.g., six TTIs, eight TTIs, etc. Notably, this may not be suitable for general traffic having a high volume/data rate (e.g., HD video). On the other hand, UAV C2 traffic is delay intolerant, but is of relatively low bandwidth and/or data volume and may thus benefit from larger TTI bundles, while minimally increasing congestion as compared to if TTI bundling were applied universally to all UAV uplink traffic.

In addition, although examples of the present disclosure are primarily associated with TTI bundling for uplink C2 traffic, in one example the method 200 may extend TTI bundling to addresses downlink traffic for the UAV. For instance, C2 traffic may include commands from a ground station for the UAV to execute. Similarly, the data payload traffic may also include video to present on a screen of the UAV, audio to present via one or more speakers of the UAV, etc. In such an example, the threshold(s) for TTI bundling and/or for TTI bundle size may be different for the downlink as compared to the uplink, the channel quality measure(s) may be different, and so forth. In particular, the downlink may generally be less constrained since the base station can typically increase power. In one example, the method 200 may further include detecting that another cell provides a better channel quality measure than the serving cell, and initiating a handover to the other cell. For instance, the UAV may continue to periodically report on cells that are detectable by the UAV, e.g., along with signal strength measurements, etc. In one example, an offset may be implemented to avoid premature handover and/or to avoid bouncing between cells. This may be particularly significant for UAVs/aerial UEs which may be within communication range of even more cells than ground-based UEs, and where the number of visible cells may increase with altitude. In one example, the method 200 may be expanded or modified to include steps, functions, and/or operations, or other features described in connection with the example(s) of FIG. 1 and/or FIG. 3, or as described elsewhere herein. Thus, these and other modifications are all contemplated within the scope of the present disclosure.

In addition, although not specifically specified, one or more steps, functions, or operations of the example method 200 may include a storing, displaying, and/or outputting step as required for a particular application. In other words, any data, records, fields, and/or intermediate results discussed in the method(s) can be stored, displayed, and/or outputted either on the device executing the method or to another device, as required for a particular application. Furthermore, steps, blocks, functions or operations in FIG. 2 that recite a determining operation or involve a decision do not necessarily require that both branches of the determining operation be practiced. In other words, one of the branches of the determining operation can be deemed as an optional step. Furthermore, steps, blocks, functions or operations of the above described method(s) can be combined, separated, and/or performed in a different order from that described above, without departing from the examples of the present disclosure.

FIG. 3 depicts a high-level block diagram of a computing device or processing system specifically programmed to perform the functions described herein. For example, any one or more components or devices illustrated in FIG. 1, or described in connection with the examples of FIG. 2, may be implemented as the processing system 300. As depicted in FIG. 3, the processing system 300 comprises one or more hardware processor elements 302 (e.g., a microprocessor, a central processing unit (CPU) and the like), a memory 304, (e.g., random access memory (RAM), read only memory (ROM), a disk drive, an optical drive, a magnetic drive, and/or a Universal Serial Bus (USB) drive), a module 305 for transmitting at least one instruction to implement a transmission time interval bundling between an uncrewed aerial vehicle and a serving cell for command and control traffic in response to the identifying that at least one uplink channel quality measure is below at least a first threshold quality level, and various input/output devices 306, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like). In accordance with the present disclosure input/output devices 306 may also include antenna elements, antenna arrays, remote radio heads (RRHs), baseband units (BBUs), transceivers, power units, and so forth.

Although only one processor element is shown, it should be noted that the computing device may employ a plurality of processor elements. Furthermore, although only one computing device is shown in the Figure, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for transmitting at least one instruction to implement a transmission time interval bundling between an uncrewed aerial vehicle and a serving cell for command and control traffic in response to the identifying that at least one uplink channel quality measure is below at least a first threshold quality level (e.g., a software program comprising computer-executable instructions) can be loaded into memory 304 and executed by hardware processor element 302 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for transmitting at least one instruction to implement a transmission time interval bundling between an uncrewed aerial vehicle and a serving cell for a command and control traffic in response to the identifying that at least one uplink channel quality measure is below at least a first threshold quality level (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
obtaining, by a processing system including at least one processor deployed in a cellular network, at least one uplink channel quality measure associated with an uncrewed aerial vehicle, wherein the uncrewed aerial vehicle includes at least one cellular radio for communication with the cellular network;
identifying, by the processing system, that the at least one uplink channel quality measure is below at least a first threshold quality level; and
transmitting, by the processing system, at least one instruction to implement a transmission time interval bundling between the uncrewed aerial vehicle and a serving cell for command and control traffic of the uncrewed aerial vehicle, in response to the identifying that the at least one uplink channel quality measure is below the at least the first threshold quality level.

2. The method of claim 1, wherein data payload traffic of the uncrewed aerial vehicle is excluded from the transmission time interval bundling.

3. The method of claim 2, wherein the data payload traffic comprises image data captured by the uncrewed aerial vehicle.

4. The method of claim 2, wherein a hybrid automatic repeat request technique is applied to the data payload traffic of the uncrewed aerial vehicle.

5. The method of claim 1, wherein the command and control traffic of the uncrewed aerial vehicle is assigned to a first quality of service class, and wherein data payload traffic of the uncrewed aerial vehicle is assigned to a second quality of service class.

6. The method of claim 5, wherein the at least one instruction identifies that the transmission time interval bundling is to be applied only to the first quality of service class for the uncrewed aerial vehicle.

7. The method of claim 1, further comprising:
obtaining an identification of the uncrewed aerial vehicle and an indicator of an uncrewed aerial vehicle user equipment type.

8. The method of claim 7, wherein the transmitting of the at least one instruction is further based upon the indicator of the uncrewed aerial vehicle user equipment type.

9. The method of claim 1, wherein the at least one instruction is to implement the transmission time interval bundling between the uncrewed aerial vehicle and the serving cell for an uplink portion of the command and control traffic of the uncrewed aerial vehicle.

10. The method of claim 1, wherein the at least one instruction is to implement the transmission time interval bundling with a first number of transmission time interval repetitions.

11. The method of claim 10, further comprising:
identifying, by the processing system, that at least a second uplink channel quality measure is below at least a second threshold quality level; and
transmitting, by the processing system, at least a second instruction to increase to a second number of transmission time interval repetitions for the transmission time interval bundling.

12. The method of claim 1, further comprising:
identifying, by the processing system, that at least a third uplink channel quality measure exceeds the at least the first threshold quality level; and
transmitting, by the processing system, at least a third instruction to cease the transmission time interval bundling between the uncrewed aerial vehicle and the serving cell for the command and control traffic of the uncrewed aerial vehicle.

13. The method of claim 1, wherein the at least one uplink channel quality measure comprises at least one of:
an uplink signal to noise ratio;
an uplink retransmission measure; or
an uplink delay measure.

14. The method of claim 1, wherein the processing system is a processing system of the serving cell.

15. The method of claim 1, wherein the transmission time interval bundling comprises a slot aggregation.

16. A non-transitory computer-readable medium storing instructions which, when executed by a processing system including at least one processor deployed in a cellular network, cause the processing system to perform operations, the operations comprising:
obtaining at least one uplink channel quality measure associated with an uncrewed aerial vehicle, wherein the uncrewed aerial vehicle includes at least one cellular radio for communication with the cellular network;
identifying that the at least one uplink channel quality measure is below at least a first threshold quality level; and
transmitting at least one instruction to implement a transmission time interval bundling between the uncrewed aerial vehicle and a serving cell for command and control traffic of the uncrewed aerial vehicle, in response to the identifying that the at least one uplink channel quality measure is below the at least the first threshold quality level.

17. An apparatus comprising:
a processing system including at least one processor; and
a non-transitory computer-readable medium storing instructions which, when executed by the processing system when deployed in a cellular network, cause the processing system to perform operations, the operations comprising:
obtaining at least one uplink channel quality measure associated with an uncrewed aerial vehicle, wherein the uncrewed aerial vehicle includes at least one cellular radio for communication with the cellular network;
identifying that the at least one uplink channel quality measure is below at least a first threshold quality level; and
transmitting at least one instruction to implement a transmission time interval bundling between the uncrewed aerial vehicle and a serving cell for command and control traffic of the uncrewed aerial vehicle, in response to the identifying that the at least one uplink channel quality measure is below the at least the first threshold quality level.

18. The apparatus of claim 17, wherein a data payload traffic of the uncrewed aerial vehicle is excluded from the transmission time interval bundling.

19. The apparatus of claim 17, wherein the transmission time interval bundling is applied only to the command and control traffic of the uncrewed aerial vehicle in response to the identifying that the at least one uplink channel quality measure is below the at least the first threshold quality level, to obtain at least a second uplink channel quality measure having at least one improvement with respect to the at least one uplink channel quality measure.

20. The apparatus of claim 17, wherein the command and control traffic of the uncrewed aerial vehicle is assigned to a first quality of service class, and wherein a data payload traffic of the uncrewed aerial vehicle is assigned to a second quality of service class.
